(19) United States
(12) Patent Application Publication
(10) Pub. No.: US 2014/0110105 A1
(43) Pub. Date: Apr. 24, 2014

(54) Systems and Methods of Monitoring a Multiphase Fluid

(71) Applicant: HALLIBURTON ENERGY SERVICES, INC., Houston, TX (US)

(72) Inventors: Christopher Michael Jones, Houston, TX (US); Robert P. Freese, Pittsboro, NC (US); Michael T. Pelletier, Houston, TX (US); Robert Atkinson, Houston, TX (US)

(73) Assignee: Halliburton Energy Services, Inc., Houston, TX (US)

(21) Appl. No.: 13/657,981

(22) Filed: Oct. 23, 2012

(51) Int. Cl. G01N 21/17; E21B 43/12; G01F 1/00; E21B 47/00; G01J 1/44; G06F 19/00

(52) U.S. Cl. 166/250.01; 250/564; 702/50; 702/49; 702/24

(57) ABSTRACT

Disclosed are systems and methods for monitoring a multiphase fluid and determining a characteristic of the multiphase fluid. One system includes a flow path containing a fluid, at least one integrated computational element configured to optically interact with the fluid and thereby generate optically interacted light, at least one detector arranged to receive the optically interacted light from the at least one integrated computational element and generate an output signal corresponding to at least one characteristic of a phase of the fluid, and a signal processor communicably coupled to the at least one detector and configured to determine the at least one characteristic of the phase of the fluid.

### BACKGROUND

The present invention relates to systems and methods for monitoring a fluids in real time and, more specifically, to monitoring a multiphase fluid and determining a characteristic of the multiphase fluid.

In the oil and gas industry, as in many other industries, the ability to monitor a flow of certain fluids in pipelines or flow lines in real time offers considerable value. Oil and/or gas well operators periodically measure circulating or pumped fluids in order to accurately determine phases, volume percent, and flow rate. This information aids in improving well production, allocating royalties, properly inhibiting corrosion based on the amount of certain fluids or other adulterants present within the fluid flow, and generally determining the overall performance of a well so that appropriate production strategies may be followed when warranted.

In the oil and gas industry, most fluid flows are multiphase fluid flows that include varying volume percentages of at least water, oil, and gas, but solid particulates may also be entrained in such fluid flows. Monitoring a multiphase fluid flow can be of considerable interest in order to determine how the multiphase fluid changes over time and thereby serve as a quality control measure. Monitoring of multiphase fluid flows in a downhole environment, however, can be quite difficult in view of the extreme conditions that often exist at common borehole depths. As a result, there are relatively few ways in which multiphase fluids in the downhole environment can be effectively monitored.

In some cases, multiphase wellbore fluids are captured or otherwise sampled downhole and brought to the surface where off-line laboratory analyses, such as spectroscopic and/or wet chemical methods, are conducted. Depending on the analysis required, however, such an approach can take hours to days to complete, and even in the best case scenario, a job will often be completed prior to the analysis being obtained. Off-line, retrospective analyses can also be unsatisfactory for determining true characteristics of a fluid since the characteristics of the extracted sample of the fluid oftentimes change during the lag time between collection and analysis, thereby making the properties of the sample non-indicative of the true chemical composition or characteristic.

Another method used to monitor multiphase wellbore fluids is by drawing the fluid into a three phase separator arranged in the downhole environment. Once the fluid settles and separates, appropriate measurements are then taken on its component parts to determine the concentrations, chemical compositions, or characteristics of the fluid. Although some separation systems are able to adequately accomplish this in the downhole environment, such systems are unable to provide measurement results in real time, but instead require the fluid to settle and separate into its component constituents before analysis. Another common problem with downhole separator systems is the accuracy of the resulting measurements. For instance, measurement errors often occur when gas bubbles are entrained within an oil flow and inadvertently and get metered as oil. Similar measurement errors occur when water is entrained in the oil flow and is metered as oil, or liquid droplets are entrained in a gas flow and are inadvertently metered as part of the gas flow.

Another method used to monitor multiphase wellbore fluids is to measure the fluid dynamically with phase specific sensors tuned specifically to gas, oil, and water. Densitometers, such vibrating densitometers, are phase specific sensors that can be used to accomplish this. For example, a density is assigned to each phase in the fluid and the vibrating densitometer measures the average or bulk density for the system so that a bulk flow rate may be determined. Such methods can be adequate when dealing with a two-phase fluid or system. However, such methods are not as efficient when dealing with three-phase flows, such as multiphase fluid flows containing significant amounts of oil, gas, and water.

There is a continued and ongoing need for improved methods and systems that provide real time monitoring of multiphase fluids in harsh downhole environments and methods and systems that are able to determine the flow rate of the one or more phases of such multiphase fluids.

### SUMMARY OF THE INVENTION

The present invention relates to systems and methods for monitoring a fluids in real time and, more specifically, to monitoring a multiphase fluid and determining a characteristic of the multiphase fluid.

In some embodiments, systems are disclosed that may include a flow path containing a fluid, at least one integrated computational element configured to optically interact with the fluid and thereby generate optically interacted light, the at least one integrated computational element being configured to analyze at least one characteristic of a phase of the fluid, at least one detector arranged to receive the optically interacted light from the at least one integrated computational element and generate an output signal corresponding to at least one characteristic of a phase of the fluid, and a signal processor communicably coupled to the at least one detector and configured to determine the at least one characteristic of the phase of the fluid.

In other embodiments, methods of monitoring a fluid are disclosed. The methods may include generating optically interacted light by interacting electromagnetic radiation with the fluid and at least one integrated computational element, receiving the optically interacted light from the integrated computational element with at least one detector, generating an output signal corresponding to at least one characteristic of a phase of the fluid with the at least one detector, receiving the output signal with a signal processor communicably coupled to the at least one detector, and determining the at least one characteristic of the phase of the fluid with the signal processor.

In yet other embodiments, methods of operating a multilateral completion system are disclosed. The methods may include determining a characteristic of a phase of a first fluid in a first multilateral leg with a first optical computing device arranged within the first multilateral leg, the first optical computing device having at least one integrated computational element configured to optically interact with the first fluid, determining a characteristic of a phase of a second fluid in a second multilateral leg with a second optical computing device arranged within the second multilateral leg, the second optical computing device having at least one integrated computational element configured to optically interact with the second fluid, and modifying a production strategy in the multilateral completion system based on the characteristic of the phase of the first and second fluids.

The features and advantages of the present invention will be readily apparent to those skilled in the art upon a reading of the description of the preferred embodiments that follows.

### BRIEF DESCRIPTION OF THE DRAWINGS

The following figures are included to illustrate certain aspects of the present invention, and should not be viewed as exclusive embodiments. The subject matter disclosed is capable of considerable modifications, alterations, combinations, and equivalents in form and function, as will occur to those skilled in the art and having the benefit of this disclosure.

FIG. 1 illustrates an exemplary integrated computation element, according to one or more embodiments.

FIG. 2 illustrates an exemplary measurement system for monitoring a fluid present in a flow path, according to one or more embodiments.

FIG. 3 illustrates another exemplary measurement system for monitoring a fluid present in a flow path, according to one or more embodiments.

FIG. 4 illustrates an exemplary multilateral completion system using one or more measurement systems to monitor fluids therein, according to one or more embodiments.

### DETAILED DESCRIPTION

The present invention relates to systems and methods for monitoring a fluids in real time and, more specifically, to monitoring a multiphase fluid and determining a characteristic of the multiphase fluid.

The exemplary systems and methods described herein employ various configurations of optical computing devices, also commonly referred to as “opticoanalytical devices,” for the real-time monitoring of a fluid, such as a multiphase fluid. In operation, the exemplary systems and methods may be useful and otherwise advantageous in determining the phases of the fluid, the volume percent of each phase, and the flow rate of each phase within the fluid. The optical computing devices, which are described in more detail below, can advantageously provide real-time multiphase fluid monitoring that cannot presently be achieved with onsite analyses at a job site. A significant and distinct advantage of these devices or sensors is that they can be configured to specifically detect and/or measure a particular component or characteristic of interest of the fluid, such as the concentration of gas, water, or oil. By detecting light interactions with the fluid unique to the phases present therein, time-varying signals corresponding to each phase may be received and processed via an autocorrelation operation which may provide, for instance, a volumetric flow rate of each phase, a mass flow rate of each phase, or other properties of the phases derivable from the volumetric and/or mass flow rates.

Accordingly, the disclosed systems and methods may provide qualitative and/or quantitative analyses of a multiphase fluid, without having to extract a sample and undertake time-consuming analyses of the sample at an off-site laboratory. With the ability to undertake real-time analyses on a multiphase fluid flow, the exemplary systems and methods described herein may allow some measure of proactive or responsive control over the multiphase fluid flow, enable the collection and archival of fluid information in conjunction with operational information to optimize subsequent operations, and/or enhance the capacity for remote job execution.

Those skilled in the art will readily appreciate that the systems and methods disclosed herein may be suitable for use in the oil and gas industry since the described optical computing devices provide a cost-effective, rugged, and accurate means for monitoring multiphase hydrocarbon fluid flows, thereby facilitating the efficient management of oil/gas production. It will be further appreciated, however, that the various disclosed systems and methods are equally applicable to other technology or industrial fields including, but not limited to, the food, medical, and drug industries, industrial applications, pollution mitigation, recycling industries, mining industries, security and military industries, or any field where it may be advantageous to determine in real-time or near real-time a characteristic of fluid or a phase of the fluid.

The optical computing devices suitable for use in the present embodiments can be deployed at any number of various points within a flow path to monitor the fluid. When two or more optical computing devices are employed, various changes that may occur to the fluid between two or more points may be monitored. Depending on the location of the particular optical computing device, various types of information about the fluid can be obtained. In some cases, for example, the optical computing devices can be used to detect phases within the fluid, determine the concentration of a particular phase, and monitor changes to the detected phases that take place over time or a predetermined distance across the flow path. As a result, the volumetric and mass flow rate of each phase may be determined, and other characteristics of each phase may be derived from the volumetric and/or mass flow rate. In some embodiments, the fluid being monitored may be a single phase fluid, without departing from the scope of the disclosure.

As used herein, the term “fluid” refers to any substance that is capable of flowing, including particulate solids, liquids, gases, slurries, emulsions, powders, muds, glasses, mixtures, combinations thereof, and the like. The fluid may be a single phase or a multiphase fluid. In some embodiments, the fluid can be an aqueous fluid, including water or the like. In other embodiments, the fluid may be a non-aqueous fluid, including organic compounds, more specifically, hydrocarbons, oil, a refined component of oil, petrochemical products, and the like. In some embodiments, the fluid can be a treatment fluid or a formation fluid as found in the oil and gas industry. The fluid may also have one or more solids or solid particulate substances entrained therein. For instance, fluids can include various flowable mixtures of solids, liquids and/or gases. Illustrative gases that can be considered fluids according to the present embodiments, include, for example, air, nitrogen, carbon dioxide, argon, helium, methane, ethane, butane, and other hydrocarbon gases, combinations thereof, and/or the like.

As used herein, the term “characteristic” refers to a chemical, mechanical, or physical property of a substance, such as a fluid. A characteristic may also refer to a chemical, mechanical, or physical property of a phase of a substance or fluid. Illustrative characteristics of a substance and/or a phase of the substance that can be detected or otherwise monitored with the optical computing devices disclosed herein can include, for example, chemical composition (e.g., identity and concentration in total or of individual components), phase presence, impurity content, pH, viscosity, density, ionic strength, total dissolved solids, salt content, porosity, opacity, bacteria content, combinations thereof, state of matter (solid, liquid, gas, emulsion, mixtures, etc.), and the like. Exemplary characteristics of a phase of substance, such as a fluid, can include a volumetric flow rate of the phase, a mass flow rate of the phase, or other properties of the phase derivable from the volumetric and/or mass flow rate. Such properties can be determined for each phase detected in the substance or fluid. Moreover, the phrase “characteristic of interest of/in a fluid” may be used herein to refer to the characteristic of a substance or a phase of the substance contained in or otherwise flowing with the fluid.

As used herein, the term “flow path” refers to a route through which a fluid is capable of being transported between two points. In some cases, the flow path need not be continuous or otherwise contiguous between the two points. Exemplary flow paths include, but are not limited to, a flowline, a pipeline, a production tubular or tubing, an annulus defined between a wellbore and a pipeline, a hose, a process facility, a storage vessel, a tanker, a railway tank car, a transport ship or vessel, a trough, a stream, a sewer, a subterranean formation, combinations thereof, or the like. In cases where the flow path is a pipeline, or the like, the pipeline may be a pre-commissioned pipeline or an operational pipeline. In other cases, the flow path may be created or generated via movement of an optical computing device through a fluid (e.g., an open air sensor). In yet other cases, the flow path is not necessarily contained within any rigid structure, but refers to the path fluid takes between two points, such as where a fluid flows from one location to another without being contained, per se. It should be noted that the term “flow path” does not necessarily imply that a fluid is flowing therein, rather that a fluid is capable of being transported or otherwise flowable therethrough.

As used herein, the term “phase” refers generally to a state of matter of a substance or material. Exemplary phases include a solid, a liquid (aqueous), a gas, or a plasma, but may also include solid particulates or materials entrained or otherwise dissolved within the liquid or gas phases. The term “phase,” however, does not necessarily imply or otherwise refer solely to state of matter, since matter can exist in different phases at the same state of matter. Instead, phase may also refer to a sufficiently homogeneous or continuous geographical region of a substance or material that exhibits a definable border or separation point with respect to other adjacent homogeneous geographical regions. A phase may be generally immiscible with other adjacent phases. In other words, a phase is a physically distinctive form of matter that is characterized by having relatively uniform chemical and physical properties. For example, two or more phases may exist in a purely liquid or fluid state, such as a liquid/liquid or gas/gas system. Phases are Moreover, mixtures can exist in multiple phases, such as an oil phase and an aqueous phase, or a gas saturated or otherwise dissolved within an oil or an aqueous phase. Further, a gas phase may have oil and water phases dispersed therein as fine globules. In thermodynamically unstable systems, phase may further refer to an emulsion or other finely divided solids trapped in either an oil or aqueous phase.

As used herein, the term “electromagnetic radiation” refers to radio waves, microwave radiation, infrared and near-infrared radiation, visible light, ultraviolet light, X-ray radiation and gamma ray radiation.

As used herein, the term “optical computing device” refers to an optical device that is configured to receive an input of electromagnetic radiation associated with a fluid, or a phase of the fluid, and produce an output of electromagnetic radiation from a processing element arranged within the optical computing device. The processing element may be, for example, an integrated computational element (ICE) used in the optical computing device. The electromagnetic radiation that optically interacts with the processing element is changed so as to be readable by a detector, such that an output of the detector can be correlated to a characteristic of the fluid or a phase of the fluid. The output of electromagnetic radiation from the processing element can be reflected electromagnetic radiation, transmitted electromagnetic radiation, and/or dispersed electromagnetic radiation. Whether the detector analyzes reflected, transmitted, or dispersed electromagnetic radiation may be dictated by the structural parameters of the optical computing device as well as other considerations known to those skilled in the art. In addition, emission and/or scattering of the fluid or a phase thereof, for example via fluorescence, luminescence, Raman, Mie, and/or Raleigh scattering, can also be monitored by the optical computing devices.

As used herein, the term “optically interact” or variations thereof refers to the reflection, transmission, scattering, diffraction, or absorption of electromagnetic radiation either on, through, or from one or more processing elements (i.e., integrated computational elements), a fluid, or a phase of the fluid. Accordingly, optically interacted light refers to electromagnetic radiation that has been reflected, transmitted, scattered, diffracted, or absorbed by, emitted, or re-radiated, for example, using an integrated computational element, but may also apply to interaction with a fluid or a phase of the fluid.

The exemplary systems and methods described herein may include at least one optical computing device arranged along or in a flow path in order to monitor a fluid flowing or otherwise contained therein. Each optical computing device may include an electromagnetic radiation source, at least one processing element (e.g., an integrated computational element), and at least one detector arranged to receive optically interacted light from the at least one processing element or the fluid. As disclosed below, however, in at least one embodiment, the electromagnetic radiation source may be omitted and instead the electromagnetic radiation may be derived from the fluid itself. In some embodiments, the exemplary optical computing devices may be specifically configured for detecting, analyzing, and quantitatively measuring a particular characteristic of interest of the fluid or a phase of the fluid in the flow path. In other embodiments, the optical computing devices may be general purpose optical devices, with post-acquisition processing (e.g., through computer means) being used to specifically detect the characteristic of the fluid or phase of the fluid.

In some embodiments, suitable structural components for the exemplary optical computing devices are described in commonly owned U.S. Pat. Nos. 6,198,531; 6,529,276; 7,123,844; 7,834,999; 7,911,605, 7,920,258, and 8,049,881, each of which is incorporated herein by reference in its entirety, and U.S. patent application Ser. Nos. 12/094,460; 12/094,465; and 13/456,467, each of which is also incorporated herein by reference in its entirety. As will be appreciated, variations of the structural components of the optical computing devices described in the above-referenced patents and patent applications may be suitable, without departing from the scope of the disclosure, and therefore, should not be considered limiting to the various embodiments or uses disclosed herein.

The optical computing devices described in the foregoing patents and patent applications combine the advantage of the power, precision and accuracy associated with laboratory spectrometers, while being extremely rugged and suitable for field use. Furthermore, the optical computing devices can perform calculations (analyses) in real-time or near real-time without the need for time-consuming sample processing. In this regard, the optical computing devices can be specifically designed to detect and analyze particular characteristics of interest of a fluid or a phase of the fluid. As a result, interfering signals are discriminated from those of interest in the fluid by appropriate configuration of the optical computing devices, such that the optical computing devices provide a rapid response regarding the characteristics of the fluid as based on the detected output. In some embodiments, the detected output can be converted into a voltage that is distinctive of the magnitude of the characteristic being monitored in the fluid.

The optical computing devices may be configured to detect as many characteristics of interest as desired in the fluid. All that is required to accomplish the monitoring of multiple characteristics is the incorporation of suitable processing and detection means within the optical computing device for each characteristic of interest. In some embodiments, the properties of the characteristic can be a combination of the properties of two or more analytes present therein (e.g., a linear, non-linear, logarithmic, and/or exponential combination). Accordingly, the more characteristics and analytes that are detected and analyzed using the optical computing devices, the more accurately the properties of the given fluid or phase of the fluid will be determined.

The optical computing devices described herein utilize electromagnetic radiation to perform calculations, as opposed to the hardwired circuits of conventional electronic processors or sensors. When electromagnetic radiation interacts with a fluid, unique physical and chemical information about the fluid or a phase within the fluid may be encoded in the electromagnetic radiation that is reflected from, transmitted through, or radiated from the fluid. This information is often referred to as the spectral “fingerprint” of the fluid. The optical computing devices described herein are capable of extracting the information of the spectral fingerprint of multiple characteristics within a fluid, and converting that information into a detectable output relating to one or more properties of the fluid or a phase within the fluid. That is, through suitable configurations of the optical computing devices, electromagnetic radiation associated with a characteristic of the fluid can be separated from electromagnetic radiation associated with all other components of the fluid in order to estimate the properties of the fluid or a phase within the fluid in real-time or near real-time.

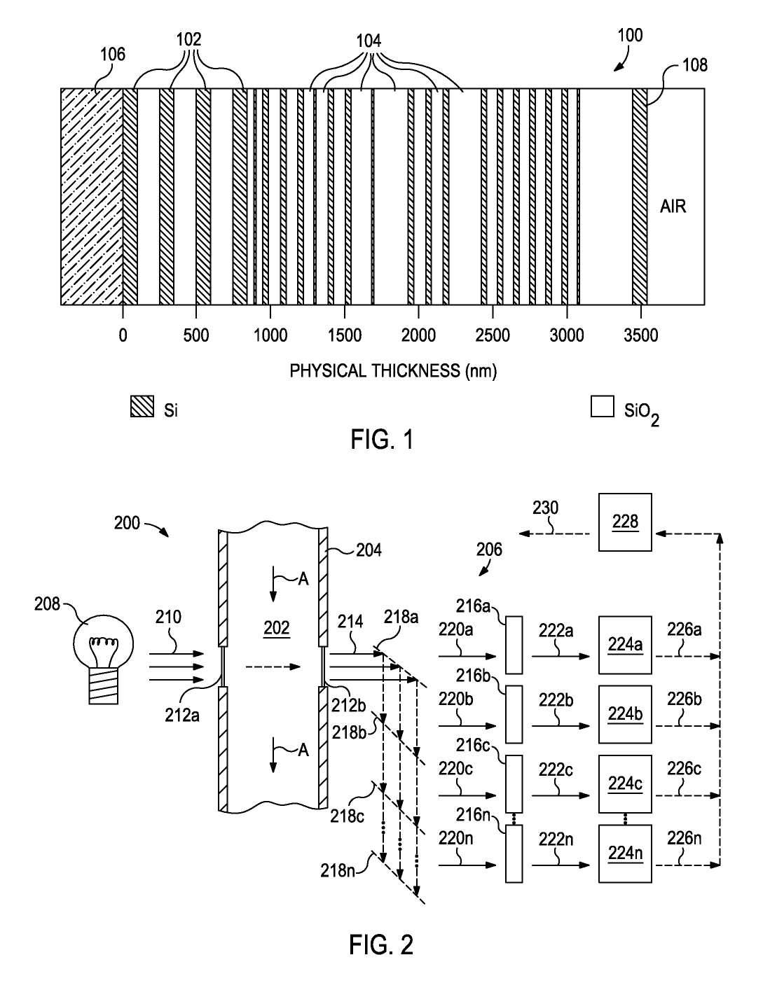

The processing elements used in the exemplary optical computing devices described herein may be characterized as integrated computational elements (ICE). Each ICE is capable of distinguishing electromagnetic radiation related to the characteristic of interest from electromagnetic radiation related to other components of a fluid. Referring to FIG. 1, illustrated is an exemplary ICE 100 suitable for use in the optical computing devices used in the systems and methods described herein. As illustrated, the ICE 100 may include a plurality of alternating layers 102 and 104, such as silicon (Si) and SiO₂ (quartz), respectively. In general, these layers 102, 104 consist of materials whose index of refraction is high and low, respectively. Other examples might include niobia and niobium, germanium and germania, MgF, SiO, and other high and low index materials known in the art. The layers 102, 104 may be strategically deposited on an optical substrate 106. In some embodiments, the optical substrate 106 is BK-7 optical glass. In other embodiments, the optical substrate 106 may be another type of optical substrate, such as quartz, sapphire, silicon, germanium, zinc selenide, zinc sulfide, or various plastics such as polycarbonate, polymethylmethacrylate (PMMA), polyvinylchloride (PVC), diamond, ceramics, combinations thereof, and the like.

At the opposite end (e.g., opposite the optical substrate 106 in FIG. 1), the ICE 100 may include a layer 108 that is generally exposed to the environment of the device or installation. The number of layers 102, 104 and the thickness of each layer 102, 104 are determined from the spectral attributes acquired from a spectroscopic analysis of a characteristic of the fluid or a phase within the fluid using a conventional spectroscopic instrument. The spectrum of interest of a given characteristic typically includes any number of different wavelengths. It should be understood that the exemplary ICE 100 in FIG. 1 does not in fact represent any particular characteristic of a given fluid or phase of the fluid, but is provided for purposes of illustration only. Consequently, the number of layers 102, 104 and their relative thicknesses, as shown in FIG. 1, bear no correlation to any particular characteristic. Nor are the layers 102, 104 and their relative thicknesses necessarily drawn to scale, and therefore should not be considered limiting of the present disclosure. Moreover, those skilled in the art will readily recognize that the materials that make up each layer 102, 104 (i.e., Si and SiO₂) may vary, depending on the application, cost of materials, and/or applicability of the material to the given fluid.

In some embodiments, the material of each layer 102, 104 can be doped or two or more materials can be combined in a manner to achieve the desired optical characteristic. In addition to solids, the exemplary ICE 100 may also contain liquids and/or gases, optionally in combination with solids, in order to produce a desired optical characteristic. In the case of gases and liquids, the ICE 100 can contain a corresponding vessel (not shown), which houses the gases or liquids. Exemplary variations of the ICE 100 may also include holographic optical elements, gratings, piezoelectric, light pipe, digital light processors (DLP), and/or acousto-optic elements, for example, that can create transmission, reflection, and/or absorptive properties of interest.

The multiple layers 102, 104 exhibit different refractive indices. By properly selecting the materials of the layers 102, 104 and their relative thickness and spacing, the ICE 100 may be configured to selectively pass/reflect/refract predetermined fractions of electromagnetic radiation at different wavelengths. Each wavelength is given a predetermined weighting or loading factor. The thickness and spacing of the layers 102, 104 may be determined using a variety of approximation methods from the spectrograph of the characteristic of interest. These methods may include inverse Fourier transform (IFT) of the optical transmission spectrum and structuring the ICE 100 as the physical representation of the IFT. The approximations convert the IFT into a structure based on known materials with constant refractive indices. Further information regarding the structures and design of exemplary ICE elements (also referred to as multivariate optical elements) is provided in Applied Optics, Vol. 35, pp. 5484-5492 (1996) and Vol. 29, pp. 2876-2893 (1990), which is hereby incorporated by reference.

The weightings that the layers 102, 104 of the ICE 100 apply at each wavelength are set to the regression weightings described with respect to a known equation, or data, or spectral signature. Briefly, the ICE 100 may be configured to perform the dot product of the input light beam into the ICE 100 and a desired loaded regression vector represented by each layer 102, 104 for each wavelength. As a result, the output light intensity of the ICE 100 is related to the characteristic of interest. Further details regarding how the exemplary ICE 100 is able to distinguish and process electromagnetic radiation related to the characteristic of interest are described in U.S. Pat. Nos. 6,198,531; 6,529,276; and 7,920,258, previously incorporated herein by reference.

Referring now to FIG. 2, illustrated is an exemplary measurement system 200 for monitoring a fluid 202, according to one or more embodiments. In the illustrated embodiment, the fluid 202 may be contained or otherwise flowing within an exemplary flow path 204. The flow path 204 may be a flow line or a pipeline and the fluid 202 present therein may be flowing in the general direction indicated by the arrows A (i.e., from upstream to downstream). In some embodiments, portions of the flow path 204 may be employed downhole and fluidly connect, for example, a hydrocarbon-bearing subterranean formation and a wellhead. As will be appreciated, however, the flow path 204 may be any other type of flow path, as generally described or otherwise defined herein. In at least one embodiment, the flow path 204 may form part of an oil/gas pipeline or production tubing and may be part of a wellhead or a plurality of subsea and/or above-ground interconnecting pipelines or production tubings that interconnect various subterranean hydrocarbon reservoirs with one or more receiving/gathering platforms or process facilities. As such, portions of the flow path 204 may be arranged substantially vertical, substantially horizontal, or any directional configuration therebetween, without departing from the scope of the disclosure.

The measurement system 200 may include an optical computing device 206 configured to determine a characteristic of interest in the fluid 202 or a phase of the fluid 202 as contained within the flow path 204. In some embodiments, the device 206 may be coupled to the flow path 204 or otherwise arranged thereon as a permanent emplacement. As illustrated, the device 206 may include an electromagnetic radiation source 208 configured to emit or otherwise generate electromagnetic radiation 210. The electromagnetic radiation source 208 may be any device capable of emitting or generating electromagnetic radiation, as defined herein. For example, the electromagnetic radiation source 208 may be a light bulb, a light emitting diode (LED), a laser, a blackbody, a photonic crystal, an X-Ray source, combinations thereof, or the like. In some embodiments, a lens (not shown), or any other type of optical device configured to transmit or otherwise convey electromagnetic radiation, may be arranged to collect or otherwise receive the electromagnetic radiation 210 and direct a beam of the same toward the fluid 202.

In one or more embodiments, the optical computing device 206 in may be configured to transmit the electromagnetic radiation 210 through the fluid 202 via a first sampling window 212a and a second sampling window 212b arranged radially-opposite the first sampling window 212a on the flow path 204. One or both of the sampling windows 212a,b may be made from a variety of transparent, rigid or semi-rigid materials that are configured to allow transmission of the electromagnetic radiation 210 therethrough. For example, the sampling windows 212a,b may be made of, but is not limited to, glasses, plastics, semi-conductors, sapphires, crystalline materials, polycrystalline materials, hot or cold-pressed powders, combinations thereof, or the like. In order to remove ghosting or other imaging issues resulting from reflectance on the sampling windows 212a,b, the measurement system 200 may employ one or more internal reflectance elements (IRE), such as those described in co-owned U.S. Pat. No. 7,697,141, and/or one or more imaging systems, such as those described in co-owned U.S. patent application Ser. No. 13/456,467, the contents of each hereby being incorporated by reference.

As the electromagnetic radiation 210 passes through the fluid 202 via the first and second sampling windows 212a,b, it optically interacts with the fluid 202. Optically interacted radiation 214 is thereby generated and subsequently directed to or otherwise received by one or more ICE 216 arranged within the optical computing device 206, such as a first ICE 216a, a second ICE 216b, a third ICE 216c, and one or more additional ICE 216n. While only four ICE 216a-n are depicted, more or less could be employed, without departing from the scope of the disclosure. As illustrated, the ICE 216a-n may be arranged in parallel within the optical computing device 206 and a series of beam splitters 218a, 218b, 218c, 218n may be used to separate or otherwise redirect the optically interacted radiation 214 such that a respective beam 220a, 220b, 220c, 220n of optically interacted radiation 214 is directed toward a corresponding ICE 216a-n. Those skilled in the art will readily recognize that alternative configurations of the device 206 may allow the optically interacted radiation 214 to be generated by being scattered, diffracted, absorbed, emitted, or re-radiated by and/or from the fluid 202, without departing from the scope of the disclosure.

Each ICE 216a-n may be a spectral component substantially similar to the ICE 100 described above with reference to FIG. 1. Accordingly, in operation each ICE 216a-n may be configured to receive a portion of the optically interacted radiation 214 and produce modified electromagnetic radiation or optically interacted light 222a-n corresponding to a particular characteristic of interest of the fluid 202. As defined above, the optically interacted light 222a-n is electromagnetic radiation that has optically interacted with the ICE 216a-n, whereby an approximate mimicking of the regression vector corresponding to the characteristic of interest of the fluid 202 is obtained.

Each ICE 216a-n may then be configured to transmit its respective optically interacted light 222a-n toward a corresponding detector 224a-n for quantification of the signal. Each detector 224a-n may be any device capable of detecting electromagnetic radiation, and may be generally characterized as an optical transducer. In some embodiments, the detectors 224a-n may be, but are not limited to, a thermal detector such as a thermopile or photoacoustic detector, a semiconductor detector, a piezo-electric detector, a charge coupled device (CCD) detector, a video or array detector, a split detector, a photon detector (such as a photomultiplier tube), photodiodes, combinations thereof, or the like, or other detectors known to those skilled in the art.

Each detector 224a-n may be configured to produce an output signal in real-time or near real-time in the form of a voltage (or current) that corresponds to the particular characteristic of interest in the fluid 202. For example, each detector 224a-n may generate or otherwise transmit first, second, third, and additional output signals 226a, 226b, 226c, and 226n, respectively. The voltage returned by each detector 224a-n is essentially the dot product of the optical interaction of the optically interacted radiation 214 with the respective ICE 216a-n as a function of the concentration of the characteristic of interest of the fluid 202. As such, each output signal 226a-n produced by its corresponding detector 224a-n and the concentration of the characteristic of interest in the fluid 202 may be related.

The output signals 226a-n may then be received by a signal processor 228 communicably coupled to each detector 224a-n. The signal processor 228 may be a computer including a processor and a machine-readable storage medium having instructions stored thereon, which, when executed by the processor, cause the optical computing device 206 to perform a number of operations, such as determining a characteristic of interest of the fluid 202 or a phase of the fluid 202. In real-time or near real-time, the signal processor 228 may be configured to provide a resulting output signal 230 corresponding to the characteristic of the fluid 202 or a phase of the fluid 202. In some embodiments, the resulting output signal 230 may be conveyed, either wired or wirelessly, to an operator for consideration. In other embodiments, the resulting output signal 230 may be recognized by the signal processor 228 as being within or without a predetermined or preprogrammed range of suitable operation. If the resulting output signal 230 exceeds the predetermined or preprogrammed range of operation, the signal processor 228 may be configured to alert the operator so appropriate corrective action may be taken, or otherwise autonomously undertake the appropriate corrective action such that the resulting output signal 230 returns to a value within the predetermined or preprogrammed range of operation.

In exemplary operation, each ICE 216a-n may be configured to detect a different characteristic of the fluid 202 or phase of the fluid 202. As a result, each output signal 226a-n may be different, and the resulting output signal 230 may provide an operator with several pieces of valuable data regarding the fluid 202 within the flow path 204. One exemplary characteristic that may be monitored by the device 206 includes the specific states of matter present within the fluid. Another exemplary characteristic that may be determined with the device is the particular phases of the fluid 202 (e.g., water, gas, oil, etc.). For instance, the first ICE 216a may be configured to detect an aqueous phase in the fluid 202, the second ICE 216b may be configured to detect a gas phase in the fluid 202, and the third ICE 216c may be configured to detect an oil phase in the fluid 202. As a result, the device 206 may be able to provide the operator with data regarding which phases are present within the fluid 202 and their respective concentrations. In other embodiments, a single ICE 216a-c may be employed to detect more than one phase characteristic of the fluid 202. For example, one or more of the ICE 216a-c may be used to detect the concentration of methane, and simultaneously determine its state of matter, e.g., gas, solid, liquid, or a mixture/combination thereof.

Other characteristics of the fluid 202 or a phase of the fluid 202 that may be detected with the device 206 include, but are not limited to, salt content, methane concentration, sand or other particulate concentration, hydrogen sulfide (H₂S) concentration, scale and/or hydrates (e.g., calcium carbonate) concentration, various ions of interest such as, but not limited to, Al⁺³, B⁺³, Ba⁺², Sr⁺, Fe²⁺, Fe³⁺ (or total Fe), I⁻, Mn²⁺, SO₄²⁻, CO₃²⁻, Ca²⁺, Mg²⁺, Mn⁴⁺, Na⁺, K⁺, Cl⁻, Sr⁺, Zn²⁺, sulfates, sulfides, carbonates, oxides, fluid states of matter (e.g., gas, solid, liquid, and mixtures or associated compositions thereof), total dissolved solids, pH, density, combinations thereof, and the like. Accordingly, the signal processor 228 may be configured to receive the various output signals 226a-n and provide the operator with one or more characteristics of the fluid 202 and/or the phase(s) of the fluid 202 in the form of the resulting output signal 230.

Yet other characteristics of the fluid 202 or a phase of the fluid 202 that may be detected with the device 206 may include a concentration of dissolved gas(es) within a liquid phase. Knowing such concentration(s), and the pressure and temperature profile that such fluids 202 will traverse within the flow path 204, may allow for the prediction of both where and how much gas will break out of these fluids 202. This data can be used to optimize production capability of the well through the particular flow path 204. For example, two or three phase flow holds the optimization problem driven by the increasing viscosity of the liquids as gas is gradually evolved therefrom. This is combined with the increasing volume of the gas phase, as both more gas is evolved from liquids, and pressure driven expansion as the pressure applied as head is gradually reduced during the trip to the surface production facility (i.e., a well head). As will be appreciated by those skilled in the art, downhole measurement, the availability of multiple zones producing different fluids, the ability to control downhole production intervals, and well head pressure can be optimized to allow a maximum liquid production from a well where the production constraint is either the flow path 204 (e.g., production tubular) capacity, the separation capacity (e.g., gas limiting) or the capability of submersible lift.

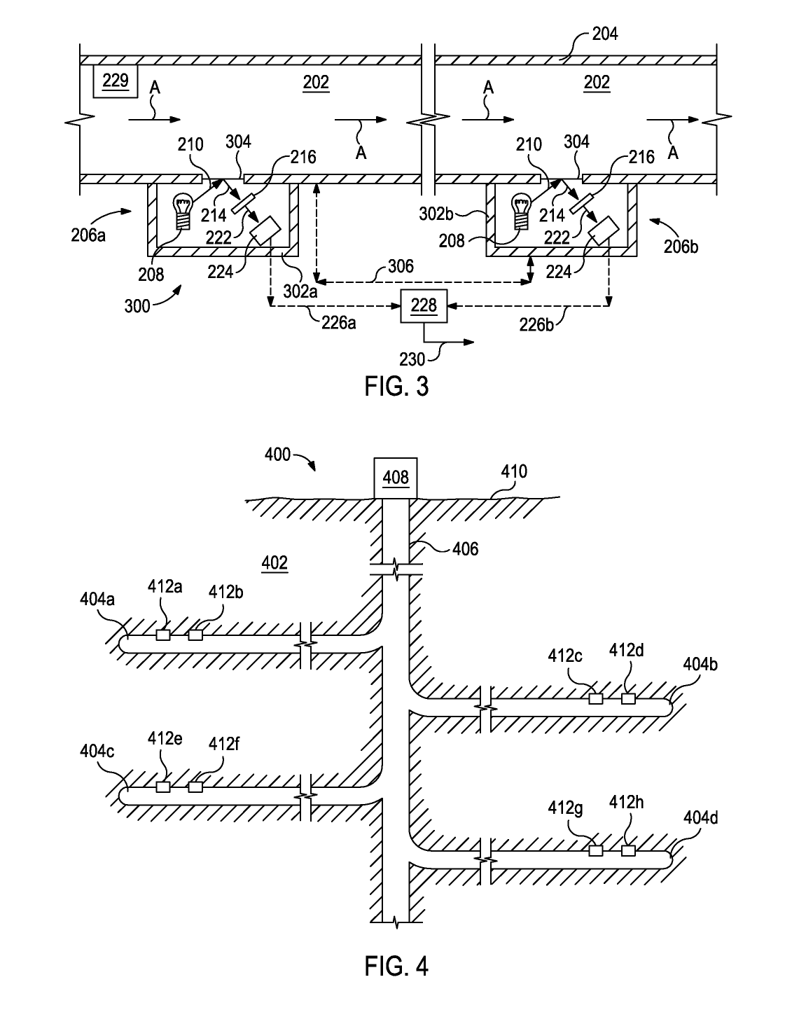

Referring now to FIG. 3, with continued reference to FIG. 2, illustrated is another exemplary measurement system 300 for monitoring a fluid 202, according to one or more embodiments. Similar to the measurement system 200 of FIG. 2, the measurement system 300 may be configured to monitor the fluid 202 contained or otherwise flowing within an exemplary flow path 204 and determining a particular characteristic of the fluid 202 within the flow path 204, such as determining a phase or state of matter of the fluid 202, or a concentration of a characteristic or phase that may be present within the fluid 202.

As illustrated, the measurement system 300 may include at least a first optical computing device 206a and a second optical computing device 206b. The first and second optical computing devices 206a,b may be similar in some respects to the optical computing device 206 of FIG. 2, and therefore may be best understood with reference thereto where like numerals represent like elements not described again in detail. As illustrated, the first and second optical computing devices 206a,b may each be associated with the flow path 204 at independent and distinct monitoring locations along the length thereof. Specifically, the first optical computing device 206a may be located at a first monitoring location and the second optical computing device 206b may be located at a second monitoring location, where the first monitoring location fluidly communicates with the second monitoring location via contiguous portions of the flow path 204.

In some embodiments, the second optical computing device 206b is arranged at a predetermined distance from the first optical computing device 206a along the length of the flow path 204. In other embodiments, however, the first optical computing device 206a may be randomly spaced from the second optical computing device 206b, without departing from the scope of the disclosure. Moreover, while two optical computing devices 206a,b are shown in FIG. 3, it will be appreciated that the measurement system 300 may employ any number of optical computing devices (including one) within the flow path 204 and equally determine the characteristic of the fluid 202 or a phase of the fluid 202. In such embodiments, each additional optical computing device may be spaced from the first and second optical computing devices 206a,b at predetermined or random distances, depending on the application.

Each device 206a,b may be housed within an individual casing or housing coupled or otherwise attached to the flow path 204 at its respective location. As illustrated, for example, the first device 206a may be housed within a first housing 302a and the second device 206b may be housed within a second housing 302b. In some embodiments, the first and second housings 302a,b may be mechanically coupled to the flow path 204 using, for example, mechanical fasteners, brazing or welding techniques, adhesives, magnets, combinations thereof or the like. Each housing 302a,b may be configured to substantially protect the internal components of the respective optical computing devices 206a,b from damage or contamination from the external environment. Moreover, each housing 302a,b may be designed so as to withstand the pressures that may be experienced within the flow path 204 and thereby provide a fluid tight seal between the flow path 204 and the respective housing 302a,b.

In some embodiments, each device 206a,b may include the electromagnetic radiation source 208 configured to emit or otherwise generate electromagnetic radiation 210. In one or more embodiments, each device 206a,b may also include a sampling window 304 arranged adjacent the fluid 202 for detection purposes. The sampling window 304 may be similar to the sampling windows 212a,b of FIG. 2 and made from a variety of transparent, rigid or semi-rigid materials that are configured to allow transmission of the electromagnetic radiation 210 therethrough. For example, after passing through the sampling window 304, the electromagnetic radiation 210 impinges upon and optically interacts with the fluid 202. As a result, optically interacted radiation 214 is generated by and otherwise reflected from the fluid 202. Those skilled in the art, however, will readily recognize that alternative variations of the devices 206a,b may allow the optically interacted radiation 214 to be generated by being transmitted through, scattered, diffracted, absorbed, emitted, or re-radiated (e.g., via fluorescence or phosphorescence methods) by and/or from the fluid 202, without departing from the scope of the disclosure.

The optically interacted radiation 214 of each device 206a,b may be directed to or otherwise be received by an ICE 216 arranged within each corresponding device 206a,b. Each ICE 216 may be configured to receive the optically interacted radiation 214 and produce modified electromagnetic radiation or optically interacted light 222 corresponding to a particular characteristic of interest of the fluid 202 or a phase of the fluid 202.

It should be noted that, while FIG. 3 depicts the ICE 216 as receiving reflected electromagnetic radiation from the fluid 202, the ICE 216 may be arranged at any point along the optical train of the device 206a,b, without departing from the scope of the disclosure. For example, in one or more embodiments, the ICE 216 may be arranged within the optical train prior to the sampling window 304 and the optical computing device 206a,b will obtain substantially the same results. In other embodiments, the sampling window 304 may serve a dual purpose as both a transmission window and the ICE 216 (i.e., a spectral component). In yet other embodiments, the ICE 216 may generate the optically interacted radiation 222 through reflection, instead of transmission therethrough.

Moreover, while only one ICE 216 is shown in each corresponding device 206a,b, similar to the optical computing device 206 of FIG. 2, embodiments are contemplated herein which include the use of two or more ICE 216 in each device 206a,b, each being configured to detect a different characteristic of the fluid 202 or phase of the fluid 202. In some embodiments, it may be desirable to monitor more than one characteristic of the fluid 202 at a time at each location along the flow path 204. In such embodiments, various configurations of multiple ICE 216 can be used in a single optical computing device 206a,b, where each ICE 216 is configured or otherwise designed to detect a particular and/or distinct characteristic of interest in the fluid 202. For example, as illustrated and discussed in FIG. 2, two or more ICE 216 may be arranged in series or parallel within each device 206a,b and each ICE 216 may be configured to detect a different characteristic of the fluid 202, a different phase of the fluid 202, and/or a different characteristic of a phase of the fluid 202. In such embodiments, one or more beam splitters may be used to divert a portion of the electromagnetic radiation being reflected by, emitted from, or transmitted through the fluid 202 and so that it may optically interact with each ICE 216.

In other embodiments, multiple optical computing devices can be placed in parallel at each location along the length of the flow path 204, where each optical computing device contains a unique ICE 216 that is configured to detect a particular characteristic of the fluid 202. In such embodiments, for example, a beam splitter can divert a portion of the electromagnetic radiation being reflected by, emitted from, or transmitted through the fluid 202 and into each optical computing device. Each optical computing device, in turn, can be coupled to a corresponding detector or detector array that is configured to detect and analyze an output of electromagnetic radiation from the optical computing device. Parallel configurations of optical computing devices can be particularly beneficial for applications that require low power inputs and/or no moving parts.

The optically interacted light 222 generated by each ICE 216 may subsequently be conveyed to a detector 224 for quantification of the signal. The detector 224 in each device 206a,b may be configured to produce an output signal in real-time or near real-time in the form of a voltage (or current) that corresponds to the particular characteristic of interest in the fluid 202 or a phase of the fluid 202. For example, the detector 224 arranged within the first device 206a may generate a first output signal 226a, and the detector 224 arranged within the second device 206b may generate a second output signal 226b. The output signal 226a,b from each device 206a,b may be conveyed to or otherwise received by the signal processor 228. In some embodiments, the signal processor 228 may be configured to compute or otherwise identify one or more characteristics of interest of the fluid 202. In other embodiments, the signal processor 228 may be configured to compute or otherwise identify one or more phases present within the fluid 202. In yet other embodiments, the signal processor 228 may be configured to compute or otherwise identify one or more characteristics of a phase present within the fluid 202. In at least one embodiment, the first and second output signals 226a,b may be indicative of characteristics of the fluid 202, such as, but not limited to, pH, viscosity, density or specific gravity, and ionic strength, as measured at the first and second monitoring locations, respectively.

In at least one embodiment, the signal processor 228 may be configured to perform an autocorrelation operation on the collected output signals 226a,b in order to determine a characteristic of a phase of the fluid 202. In particular, for example, the autocorrelation operation may be undertaken such that a factor of fluctuation per unit time is matched to each respective phase of the fluid 202. The signal processor 228 may perform a number of operations, such as determining a characteristic of a phase of the fluid 202 based on results from performing the autocorrelation operation. Exemplary characteristics determined based on results from performing the autocorrelation operation include, but are not limited to, a volumetric flow rate of the phase, a mass flow rate of the phase, flow regime (e.g., turbulent or laminar, or combinations thereof) or other characteristics of the phase derivable from the volumetric and/or mass flow rate. The autocorrelation operation on the collected output signals 226a,b may employ one or more techniques such as, but not limited to, time evolved factor analysis, general autocorrelation, coherence and partial coherence methods, multivariate curve resolution, histogram profiling, or other similar evaluation process.

In some embodiments, a fluid stream perturbing device 229 may be operatively arranged within the flow path 204 upstream from the first and second optical computing devices 206a,b. With the autocorrelation operation based on variations or fluctuations in the phases of the fluid 202 over time, phases that are consistent over distance or mildly grading in composition and properties may be insensitive to the autocorrelation technique for determining flow rates of the phases. The fluid stream perturbing device 229 may be configured to inject a perturbation upstream of the optical computing devices 206a,b relative to a phase of the fluid 202, when the phase is flowing without sufficient variation at the respective measuring points absent the perturbation. Those skilled in the art will readily recognize that natural perturbing instances may occur in the flow path 204 such that use of the fluid stream perturbing device 229 may be reduced or eliminated altogether in some embodiments. Examples of natural perturbing instances include, but are not limited to, flow around the bend of an elbow, flow at a reducing or enlarging union, induction of a gas bubble, a change from laminar flow to turbulent flow, or other similar activities that accompany a change in flow.

The arrangement of the optical computing devices 206a,b and the evaluation of their measurements may be configured to use perturbation(s) that is/are observable by the such devices 206a,b. For instance, a perturbation may include the induction of a gas bubble, a change from laminar flow to turbulent flow, or injection of an absorbing or fluorescing dye. A single perturbation most likely affects different phases differently. However, in the case that a perturbation does not affect a given phase at all, multiple perturbations (one for each independent phase) may be induced. Relative perturbations may be induced in the case that an absolute perturbation provides less than sufficient delineating characterization. For instance, two dyes may simultaneously be injected in different concentrations to induce a relative optical density ratio between two different optical band centers. Perturbations may also be varied temporally with characteristic frequencies, beats, or cords so as to lock the pattern. Again, however, many natural perturbations occur with regular frequency that can provide the measurable perturbations without inducing a perturbation using the fluid stream perturbing device 229.

With a known distance between the first and second optical computing devices 206a,b, and/or the perturbation point, the autocorrelation function using the output signals 226a,b may yield a linear velocity for each phase observed within the fluid 202. This autocorrelation function may make use of various algorithms to perform the autocorrelation operation. Such autocorrelation algorithms may include, but are not limited to, time evolved factor analysis, general autocorrelation, multivariate curve resolution, coherence or partial coherence methods, or histogram profiling. Such algorithms can be part of an artificial neural network configured to use the concentration of each detected characteristic in order to evaluate the overall characteristic(s) of the fluid 202. Illustrative but non-limiting artificial neural networks are described in commonly owned U.S. patent application Ser. No. 11/986,763 (U.S. Patent App. Pub. No. 2009/0182693), which is incorporated herein by reference.

It is to be recognized that an artificial neural network can be trained using samples of fluids 202 having known characteristics, phases, concentrations, compositions, and/or properties, and thereby generating a virtual library. As the virtual library available to the artificial neural network becomes larger, the neural network can become more capable of accurately predicting the characteristics of the fluid 202 and any phases present therein. Furthermore, with sufficient training, the artificial neural network can more accurately predict the characteristics of the fluid 202, even in the presence of unknown characteristics.

To convert the linear flow, provided by the autocorrelation analysis of the data received from the output signals 226a,b, into volumetric flow, the fluid phase cross section can be determined at the location of each optical computing device 206a,b. To convert the linear flow into volumetric flow, an average phase volume, determined for the regions near each optical computing device 206a,b, can be determined using each optical computing device 206a,b. Alternatively, the optical computing devices 206a,b may configured to detect and determine mass flow of each detected phase. Mass flow and volumetric flow may be interconverted with known phase densities (e.g., densities for water, gases, and oils). Alternatively, if mass flow and volumetric flow are determined, then phase densities may be calculated. In addition, phase compressibility may be derived from the optical computing devices 206a,b if located at points of differing pressures within the flow path 204, or from flow velocities correlated over differing pressures, if phase velocities are known.

Accordingly, the autocorrelation operations of the signal processor 228 provide a mechanism to examiner variations in the fluid 202 across the optical computing devices 206a,b. As briefly mentioned above, one example of an autocorrelation operation can be realized by applying a time evolved factor analysis where each optical computing device 206a,b can be considered to be a different channel. An auto correlation function provided by the time evolved factor analysis provides a technique designed to match factors with factors of fluctuation across unit time. In such a system, a number of different factors may be determined, for example, two different factors or three different factors, where each factor is equivalent to the number of phases of the fluid 202. The factor fluctuation per unit time can yield a flow rate for these different phases. If the distance between the optical computing devices 206a,b is known, such a flow rate can be calculated as a volumetric flow rate. Moreover, with known densities of the composition of the fluid 202, the factor fluctuation per unit time can yield a flow rate that translates to mass. In such an analysis, the number of optical computing devices 206a,b dispersed throughout the system 300 may be configured such that they are sensitive to the different phases in the fluid 202. As will be appreciated, a combination of optical computing devices 206a,b, which yield enough degrees of freedom to physically provide the data for the different phases, can be used such that each optical computing device 206a,b need not be sensitive to all phases.

In real-time or near real-time, the signal processor 228 may be configured to provide a resulting output signal 230 corresponding to the characteristic of the fluid 202 or a phase of the fluid 202 based on the results from the autocorrelation operation. In some embodiments, the resulting output signal 230 may be conveyed, either wired or wirelessly, to an operator for consideration. In other embodiments, the resulting output signal 230 may be recognized by the signal processor 228 as being within or without a predetermined or preprogrammed range of suitable operation. If the resulting output signal 230 exceeds the predetermined or preprogrammed range of operation, the signal processor 228 may be configured to alert the operator so appropriate corrective action may be taken, or otherwise autonomously undertake the appropriate corrective action such that the resulting output signal 230 returns to a value within the predetermined or preprogrammed range of operation.

Still referring to FIG. 3, in other embodiments, one of the optical computing devices 206a,b may be omitted from the system 300, such as the first optical computing device 206a, and an optical light pipe 306 may be included to facilitate the monitoring and/or detection of the fluid 202 at or near the first monitoring location. In alternative embodiments, it will be appreciated that the second optical computing device 206b may instead be omitted and the optical light pipe 306 may be used to monitor the fluid 202 at or near the second monitoring location, and equally obtain the same results.

The optical light pipe 306 may be a fiber optic lead, probe, or conduit used for the transmission of electromagnetic radiation to/from the second optical computing device 206b. The optical light pipe 306 may communicably couple the second optical computing device 206b to the fluid 202 at or near the first monitoring location. For example, the optical light pipe 306 may be configured to convey electromagnetic radiation from the second optical computing device 206b to the fluid 202 for the purpose of determining the particular characteristic of the fluid 202 or a phase of the fluid 202. The optical light pipe 306 may also be configured to convey optically interacted radiation from the fluid 202 back to the second optical computing device 206b.

In exemplary operation, the second optical computing device 206b may receive optically interacted radiation from the fluid 202 at both the first and second monitoring locations. The detector 224 arranged within the second optical computing device 206b may be configured to time multiplex the dual beams of optically interacted light from the fluid 202 derived from each monitoring location. For example, the optically interacted radiation received via the optical light pipe 306 at the first monitoring location may be directed to or otherwise received by the second optical computing device 206b at a first time T1, and the optically interacted radiation derived at the second monitoring location may be directed to or otherwise received by the second optical computing device 206b at a second time T2, where the first and second times T1, T2 are distinct time periods that do not spatially overlap.

Consequently, the detector 224 receives at least two distinct beams of optically interacted light from the ICE 216 and is able to convey corresponding output signals 226b for the respective beams to the signal processor 228 for processing. The first beam of optically interacted light may indicate a characteristic of the fluid 202 at the first monitoring location, while the second beam of optically interacted light may indicate the characteristic of the fluid 202 at the second monitoring location. By employing one or more autocorrelation operations as discussed herein above, the signal processor 228 may be able to determine particular phase characteristics of the fluid 202, such as volumetric and mass flow rates, flow regimes (e.g., turbulent or laminar, or combinations thereof), or other characteristics of the phase(s) derivable from the volumetric and/or mass flow rate.

Still referring to FIG. 3, with continued reference to FIG. 2, those skilled in the art will readily recognize that, in one or more embodiments, electromagnetic radiation may be derived from the fluid 202 itself, and otherwise derived independent of the electromagnetic radiation source 208. For example, various substances naturally radiate electromagnetic radiation that is able to optically interact with the ICE 216. In some embodiments, for example, the fluid 202 or a phase within the fluid 202 may be a blackbody radiating substance configured to radiate heat that may optically interact with the ICE 216. In other embodiments, the fluid 202 or a phase within the fluid 202 may be radioactive or chemo-luminescent and, therefore, radiate electromagnetic radiation that is able to optically interact with the ICE 216. In yet other embodiments, the electromagnetic radiation may be induced from the fluid 202 or a phase within the fluid 202 by being acted upon mechanically, magnetically, electrically, combinations thereof, or the like. For instance, in at least one embodiment, a voltage may be placed across the fluid 202 in order to induce the electromagnetic radiation. As a result, embodiments are contemplated herein where the electromagnetic radiation source 208 is omitted from the optical computing device(s) 206.

Those skilled in the art will readily appreciate the various and numerous applications that the measurement systems 200 and 300, and their various alternative configurations, may be suitably used with. For instance, referring to FIG. 4, illustrated is an exemplary multilateral completion system 400 that may employ a plurality of measurement systems, such as measurement systems similar to the measurement systems 200, 300 described above, in order to intelligently control hydrocarbon production from one or more subterranean formations 402. Specifically, the multilateral completion system 400 may include a plurality of multilateral legs 404a, 404b, 404c, and 404d that extend into the one or more subterranean formations 402. Each multilateral leg 404a-d may be representative of a corresponding collection tubular or pipeline installed in a corresponding multilateral wellbore drilled into the one or more subterranean formations 402. Each collection tubular or pipeline in the associated multilateral legs 404a-d may have one or more interval control valves, movable sleeves, inflow control devices, or other flow control devices known to those skilled in the art and configured to regulate the fluid communication between the subterranean formation and each respective multilateral leg 404a-d.

Each multilateral leg 404a-d may be fluidly coupled to a common production tubular 406 that extends into the subterranean formation 402 from a wellhead 408 arranged at a surface 410. Fluids produced into each multilateral leg 404a-d are collected and combined in the common production tubular 406 which conveys the fluids to the wellhead 408 for further processing or transport to another facility. Accordingly, the collection tubulars or pipelines arranged within each multilateral leg 404a-d and the common production tubular 406 may be characterized as portions of a flow path, such as the flow path 204 discussed above. While only four multilateral legs 404a-d are illustrated in FIG. 4, it will be appreciated that more or less than four may be included, without departing from the scope of the disclosure. Moreover, the surface 410 may be representative of an open-air geographical location, such as is the case of a land-based oil and gas rig, or otherwise may represent a subsea location where the wellhead 408 is located on the sea floor, without departing from the scope of the disclosure.

The multilateral completion system 400 may further include a plurality of measurement systems (shown in FIG. 4 as measurement systems 412a-412h) coupled to or otherwise arranged on the collection tubulars or pipelines disposed within each multilateral leg 404a-d. In at least one embodiment, one or more of the measurement systems 412a-h may be arranged within a gas lift mandrel pocket defined or otherwise formed within a corresponding collection tubular or pipeline. Each measurement system 412a-h may be substantially similar to one or both of the measurement systems 200, 300 described herein, and therefore will not be described in detail. Briefly, however, each measurement system 412a-h may include at least one optical computing device having one or more ICE 216 (FIGS. 2 and 3) configured to monitor the fluids within each multilateral leg 404a-d and determine one or more characteristics thereof. As illustrated, each multilateral leg 404a-d includes two measurement systems 412a-h, but it will be appreciated that more or less than two measurement systems 412a-h may be employed in each leg 404a-d, without departing from the scope of the disclosure.

In some embodiments, one or more of the measurement systems 412a-h may be configured to monitor the fluids close to the sand face in each multilateral leg 404a-d as they are being produced into the collection tubulars or pipelines from the subterranean formation 402. In other embodiments, however, one or more of the measurement systems 412a-h may be configured to monitor fluids at any portion of the multilateral completion system 400, without departing from the scope of the disclosure. For instance, in some embodiments, additional measurement systems (not shown) may be arranged at or near the common production tubular 406 or on the common production tubular 406 itself. The measurement systems 412a-h may be configured to detect and report several characteristics of the fluids to an operator such as, but not limited to, phases of the fluid, chemical composition and concentration of the produced fluid, phase densities, phase flow rates, mass flow rates, sand production, etc.

Those skilled in the art will readily recognize the several advantages this affords. For example, the measurement systems 412a-h may be able to measure and report in real time characteristics of the fluid(s) in each multilateral leg 404a-d, thereby providing an operator with valuable data as to what each multilateral leg 404a-d is producing and in what quantities and at what rate. With such information on hand, the operator may be able to intelligently and more efficiently produce the hydrocarbons from each leg 404a-d of the multilateral completion system 400. For example, the operator may be able to manipulate various flow control devices, such as one or more interval control valves, movable sleeves, and/or inflow control devices, in the collection tubulars in each multilateral leg 404a-d, thereby strategically producing hydrocarbons from the more efficient production intervals within the multilateral completion system 400.

Such real time information may also be able to inform the operator of current or potential problems in any of the multilateral legs 404a-d. For instance, if a water burst occurs in the first multilateral leg 404a, the measurement system(s) 412a and/or 412b arranged therein may be able to report such an occurrence to the operator by determining the phase and/or other characteristics of the fluid(d) being produced at that location. Moreover, if a particular production zone or interval in the second multilateral leg 404b begins to produce sand, H₂S, asphaltenes, saturates or any other unwanted substance or fluid, the corresponding measurement system(s) 412c and/or 412d may be able to determine which substances are being produced, their concentration and/or other characteristics, and report such an occurrence to the operator. As a result, the operator may be able to proactively adjust production strategies or potentially take corrective action, such as initiating one or more remedial treatments, in an effort to ameliorate the any adverse effects.

In other embodiments, using the data obtained from the measurement systems 412a-h, bubble point and dew point may be directly determined, pump out rates may be maximized, and cleanup can be monitored for multiphase contamination. Moreover, when used in production monitoring, the measurement systems 412a-h may be configured to determine the fraction of the total flow rate produced from a multilateral leg 404a-d that is due to water for flooding operations and report the same to the operator for consideration. Moreover, the fraction of the total flow rate produced from each multilateral leg 404a-d that is due to gas can be determined for enhanced oil recovery, and artificial lift or particulates content may be determined for sand control purposes.

In some embodiments, the data collected using the measurement systems 412a-h can be archived along with data associated with operational parameters being logged at a job site. Evaluation of job performance can then be assessed and improved for future operations or such information can be used to design subsequent operations. In addition, the data and information can be communicated (wired or wirelessly) to a remote location by a communication system (e.g., satellite communication or wide area network communication) for further analysis. The communication system can also allow remote monitoring and operation of a process to take place. Automated control with a long-range communication system can further facilitate the performance of remote job operations. In particular, an artificial neural network can be used in some embodiments to facilitate the performance of remote job operations. That is, remote job operations can be conducted automatically in some embodiments. In other embodiments, however, remote job operations can occur under direct operator control, where the operator is not at the job site.

It is recognized that the various embodiments herein directed to computer control and artificial neural networks, including various blocks, modules, elements, components, methods, and algorithms, can be implemented using computer hardware, software, combinations thereof, and the like. To illustrate this interchangeability of hardware and software, various illustrative blocks, modules, elements, components, methods and algorithms have been described generally in terms of their functionality. Whether such functionality is implemented as hardware or software will depend upon the particular application and any imposed design constraints. For at least this reason, it is to be recognized that one of ordinary skill in the art can implement the described functionality in a variety of ways for a particular application. Further, various components and blocks can be arranged in a different order or partitioned differently, for example, without departing from the scope of the embodiments expressly described.

Computer hardware used to implement the various illustrative blocks, modules, elements, components, methods, and algorithms described herein can include a processor configured to execute one or more sequences of instructions, programming stances, or code stored on a non-transitory, computer-readable medium. The processor can be, for example, a general purpose microprocessor, a microcontroller, a digital signal processor, an application specific integrated circuit, a field programmable gate array, a programmable logic device, a controller, a state machine, a gated logic, discrete hardware components, an artificial neural network, or any like suitable entity that can perform calculations or other manipulations of data. In some embodiments, computer hardware can further include elements such as, for example, a memory (e.g., random access memory (RAM), flash memory, read only memory (ROM), programmable read only memory (PROM), erasable read only memory (EPROM)), registers, hard disks, removable disks, CD-ROMS, DVDs, or any other like suitable storage device or medium.

Executable sequences described herein can be implemented with one or more sequences of code contained in a memory. In some embodiments, such code can be read into the memory from another machine-readable medium. Execution of the sequences of instructions contained in the memory can cause a processor to perform the process steps described herein. One or more processors in a multi-processing arrangement can also be employed to execute instruction sequences in the memory. In addition, hard-wired circuitry can be used in place of or in combination with software instructions to implement various embodiments described herein. Thus, the present embodiments are not limited to any specific combination of hardware and/or software.

As used herein, a machine-readable medium will refer to any medium that directly or indirectly provides instructions to a processor for execution. A machine-readable medium can take on many forms including, for example, non-volatile media, volatile media, and transmission media. Non-volatile media can include, for example, optical and magnetic disks. Volatile media can include, for example, dynamic memory. Transmission media can include, for example, coaxial cables, wire, fiber optics, and wires that form a bus. Common forms of machine-readable media can include, for example, floppy disks, flexible disks, hard disks, magnetic tapes, other like magnetic media, CD-ROMs, DVDs, other like optical media, punch cards, paper tapes and like physical media with patterned holes, RAM, ROM, PROM, EPROM and flash EPROM.

It should also be noted that the various drawings provided herein are not necessarily drawn to scale nor are they, strictly speaking, depicted as optically correct as understood by those skilled in optics. Instead, the drawings are merely illustrative in nature and used generally herein in order to supplement understanding of the systems and methods provided herein. Indeed, while the drawings may not be optically accurate, the conceptual interpretations depicted therein accurately reflect the exemplary nature of the various embodiments disclosed.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

The invention claimed is:

1. A system, comprising:
a flow path containing a fluid;
at least one integrated computational element configured to optically interact with the fluid and thereby generate optically interacted light, the at least one integrated computational element being configured to analyze at least one characteristic of a phase of the fluid;
at least one detector arranged to receive the optically interacted light from the at least one integrated computational element and generate an output signal corresponding to the at least one characteristic of a phase of the fluid; and
a signal processor communicably coupled to the at least one detector and configured to determine the at least one characteristic of the phase of the fluid.

2. The system of claim 1, wherein the fluid is a multiphase fluid comprising one or more of an aqueous phase, an oil phase, and a gas phase.

3. The system of claim 2, wherein the at least one characteristic of the phase of the fluid is a concentration of one of the phases of the multiphase fluid.

4. The system of claim 1, wherein the at least one characteristic of the phase of the fluid is a state of matter of one of the phases present within the fluid.

5. The system of claim 1, wherein the at least one integrated computational element comprises a plurality of integrated computational elements configured to optically interact with the fluid at a corresponding plurality of monitoring locations on the flow path, and
wherein the at least one detector receives optically interacted light from each integrated computational element and generates a corresponding plurality of output signals corresponding to the at least one characteristic of the phase of the fluid.

6. The system of claim 5, wherein the signal processor performs an autocorrelation operation on the plurality of output signals such that a factor of fluctuation per unit time is matched to each respective phase of the fluid.

7. The system of claim 6, wherein the at least one characteristic of the phase of the fluid is determined based on results of performing the autocorrelation operation.

8. The system of claim 7, wherein the autocorrelation operation includes using one or more of a time evolved factor analysis, a general autocorrelation, a multivariate curve resolution, coherence and partial coherence methods, and a histogram profiling.

9. The system of claim 6, wherein the at least one characteristic of the phase of the fluid comprises a volumetric flow rate of the phase.

10. The system of claim 6, wherein the at least one characteristic of the phase of the fluid comprises a mass flow rate of the phase.

11. A method of monitoring a fluid, comprising:
generating optically interacted light by interacting electromagnetic radiation with the fluid and at least one integrated computational element;
receiving the optically interacted light from the integrated computational element with at least one detector;
generating an output signal corresponding to at least one characteristic of a phase of the fluid with the at least one detector;
receiving the output signal with a signal processor communicably coupled to the at least one detector; and
determining the at least one characteristic of each phase of the fluid with the signal processor.

12. The method of claim 11, wherein the fluid is a multiphase fluid comprising one or more of an aqueous phase, an oil phase, and a gas phase, and wherein determining the at least one characteristic of the phase of the fluid further comprises determining a concentration of one phase of the multiphase fluid.

13. The method of claim 11, wherein determining the at least one characteristic of the phase of the fluid further comprises determining a state of matter of one phase present within the fluid.

14. The method of claim 11, wherein the at least one integrated computational element comprises a plurality of integrated computational elements, the method further comprising:
optically interacting the plurality of integrated computational elements with the fluid at a corresponding plurality of monitoring locations on the flow path;
receiving optically interacted light from each integrated computational element with the at least one detector and thereby generating a corresponding plurality of output signals corresponding to the at least one characteristic of the phase of the fluid; and
performing an autocorrelation operation on the plurality of output signals such that a factor of fluctuation per unit time is matched to each respective phase of the fluid, thereby determining the at least one characteristic of the phase of the fluid.

15. The method of claim 14, wherein determining the at least one characteristic of the phase of the fluid further comprises determining the at least one characteristic based on results from performing the autocorrelation operation.

16. The method of claim 14, wherein determining the at least one characteristic of the phase of the fluid further comprises determining a volumetric flow rate of the phase.

17. The method of claim 14, wherein determining the at least one characteristic of the phase of the fluid further comprises determining a mass flow rate of the phase.

18. The method of claim 14, further comprising injecting a perturbation into the fluid upstream of the plurality of integrated computational elements.

19. A method of operating a multilateral completion system, comprising:
determining a characteristic of a phase of a first fluid in a first multilateral leg with a first optical computing device arranged within the first multilateral leg, the first optical computing device having at least one integrated computational element configured to optically interact with the first fluid;
determining a characteristic of a phase of a second fluid in a second multilateral leg with a second optical computing device arranged within the second multilateral leg, the second optical computing device having at least one integrated computational element configured to optically interact with the second fluid; and
modifying a production strategy in the multilateral completion system based on the characteristic of the phase of the first and second fluids.

20. The method of claim 19, wherein:
determining the characteristic of the phase of the first fluid further comprises:
generating a plurality of output signals corresponding to the characteristic of the phase of the first fluid with at least one detector arranged within the first optical computing device;
receiving the first plurality of output signals with a signal processor communicably coupled to the at least one detector; and
determining the at least one characteristic of the phase of the first fluid with the signal processor; and
determining the characteristic of the phase of the second fluid further comprises:
generating a plurality of output signals corresponding to the characteristic of the phase of the second fluid with at least one detector arranged within the second optical computing device;
receiving the second plurality of output signals with a signal processor communicably coupled to the at least one detector; and
determining the at least one characteristic of the phase of the second fluid with the signal processor.

21. The method of claim 20, wherein:
determining the characteristic of the phase of the first fluid further comprises performing an autocorrelation operation on the plurality of output signals such that a factor of fluctuation per unit time is matched to each respective phase of the first fluid, the characteristic of the phase of the first fluid being determined based on results from performing the autocorrelation operation; and
determining the characteristic of the phase of the second fluid further comprises performing an autocorrelation operation on the plurality of output signals such that a factor of fluctuation per unit time is matched to each respective phase of the second fluid, the characteristic of the phase of the second fluid being determined based on results from performing the autocorrelation operation.

22. The method of claim 19, wherein:
determining the characteristic of the phase of the first fluid further comprises determining a volumetric flow rate of the phase of the first fluid; and
determining the characteristic of the phase of the second fluid further comprises determining a volumetric flow rate of the phase of the second fluid.

23. The method of claim 19, wherein:
determining the characteristic of the phase of the first fluid further comprises determining a mass flow rate of the phase of the first fluid; and
determining the characteristic of the phase of the second fluid further comprises determining a mass flow rate of the phase of the second fluid.

24. The method of claim 19, wherein modifying a production strategy in the multilateral completion system further comprises adjusting one or more flow control devices arranged within one or both of the first and second multilateral legs, thereby regulating a fluid flow within one or both of the first and second multilateral legs.

25. The method of claim 19, wherein one or both of the first and second fluids is a multiphase fluid comprising one or more of an aqueous phase, an oil phase, and a gas phase, and wherein:
determining the at least one characteristic of the phase of the first fluid further comprises determining a concentration of at least one phase of the first fluid; and
determining the at least one characteristic of the phase of the second fluid further comprises determining a concentration of at least one phase of the second fluid.

26. The method of claim 19, wherein:
determining the at least one characteristic of the phase of the first fluid further comprises determining a state of matter of at least one phase present within the first fluid; and
determining the at least one characteristic of the phase of the second fluid further comprises determining a state of matter of at least one phase present within the second fluid.
